(19) United States
(12) Patent Application Publication
(10) Pub. No.: US 2010/0228987 A1
(43) Pub. Date: Sep. 9, 2010

(54) System and method for securing information using remote access control and data encryption

(75) Inventor: Konstantin D Dinov, San Diego, CA (US)

Correspondence Address: RADER FISHMAN & GRAUER PLLC, LION BUILDING, 1233 20TH STREET N.W., SUITE 501, WASHINGTON, DC, 20036, US

(73) Assignees: Sony Corporation, Tokyo (JP); Sony Electronics Inc., Park Ridge, NJ (US)

(21) Appl. No.: 12/382,023

(22) Filed: Mar. 6, 2009

(51) Int. Cl. H04L 9/32; G06F 21/00

(52) U.S. Cl. 713/183; 726/7

(57) ABSTRACT

The invention relates to a system and method for enhancing the security of information by decoupling the user authentication from the data storage and access. User information, stored by a service provider, is encrypted using a hashed password and access to the encrypted user information is protected by a separate access control server. The access control server and service provider may be provided a uniquely hashed first and second password, respectively. The access control server uses the first hashed password to allow the user access to the service provider, and the service provider then decrypts the user information using the second hashed password. The system ensures that even if the malicious user manages to compromise either the service provider or the access control server the malicious user would remain unable to decrypt and access any stored user information.

### BACKGROUND OF THE INVENTION

1. Field of the Invention

This invention relates generally to a system and method for implementing enhanced encryption and authentication by decoupling the user authentication from data storage and access, and more particularly, to a system and method whereby user information stored by a service provider is encrypted using a Transient Password and whereby access to the encrypted user information is protected by a separate access control server.

2. Description of the Related Art

Computer systems and networks implement access control mechanisms to permit or deny a given entity access to a particular service or resource. Access control mechanisms ensure the security of digital resources which may contain private or critical information. Most access control implementations can be broken down into an authentication process and an authorization process.

An authentication process is the process by which a system verifies the identity of the user attempting to access the system. Authentication generally begins when a user logs onto a system using a client device (e.g. laptop, PDA, desktop computer, terminal device, etc.), by providing a user identification (user ID) and a password. The user ID is a token that uniquely identifies a given user, such as a username, fingerprint, retina scan, etc. A password is a token that confirms the identity of the user. The password may be a character string, smart card, etc. In some cases, the user ID and password may comprise the same token such as smart card, retina scan, voice recognition, or fingerprints.

An authorization process involves determining what resources or services an identified user is permitted to access and granting access to those same resources or services. Permission to access a given resource or service can be granted or denied based on a wide variety of criteria, such as a user group, network address, time of day, browser type, etc.

FIG. 1 illustrates a conventional authentication and authorization system including a client 10, Cryptograph Module 20, and Service Provider 30 connected via network 5.

The authentication process between the client 10 and the Service Provider 30 begins when a user (not shown) inputs login information to client 10. Client 10 transmits the login information to a Cryptograph Module 20. The login information includes a user ID and password. The Cryptograph Module 20 generates a hashed password by applying a cryptographic scheme to the password. The Cryptograph Module 20 transmits the user ID and hashed password to the Service Provider 30. The Service Provider 30 then compares the hashed password against an expected password based on the user ID. If the hashed password and expected password match, client 10 is then permitted to access the resource or service provided by the Service Provider 30, which may include access to a user information database 35.

The illustrated conventional authentication and authorization system suffers from the problem whereby, if a malicious user obtains unauthorized access to Service Provider 30, then the malicious user will be able to gain access to the user information database 35, which may include private user information. Alternatively, if a malicious user manages to intercept communications transmitted to the Service Provider 30, then the unauthorized user may be able to obtain the user ID and hashed password for a given user, and thereby access that user's information on the user information database 35 corresponding to that particular user ID.

While user information database 35 may be further protected by encrypting the user information database 35 by using a master key, the master key would need to be stored locally to the Service Provider 30 to regularly decrypt the user information. Therefore, a malicious user that gains access to the Service Provider 30 may also gain access to the user information by obtaining the stored master key. Furthermore, since only a single key is necessary to decrypt the entire user information database 35, a malicious user only needs to obtain a single key to obtain access to the database.

Accordingly, it would be beneficial to provide an access control mechanism whereby a malicious user would be unable to access any user information even if the malicious user obtains a given user ID and hashed password, or manages to obtain access to the user information database 35 even if the Service Provider 30 or user information database 35 are compromised.

### SUMMARY OF THE INVENTION

The present invention provides a SYSTEM AND METHOD FOR SECURING INFORMATION USING REMOTE ACCESS CONTROL AND DATA ENCRYPTION.

An example embodiment of the present embodiment includes an authentication system and method that employs an access control mechanism whereby a malicious user would be unable to access any user information even if the malicious user obtains a given user ID and hashed password, or manages to obtain access to the user information database even if the service provider or the service provider's information database are compromised.

The example authentication system may include a cryptograph module, an access control server, and a service provider.

The cryptograph module may receive a user password from a client terminal and generate a first password using a first one-way cryptographic scheme and a second password using a second one-way cryptographic scheme. The first one-way cryptographic scheme and second one-way cryptographic scheme may be different cryptographic schemes, and may include MD5, SHA, DSA, and RSA, but is not limited thereto.

The access control server may include an access control database that stores an Access Password, and an interface for: communicating with the cryptograph module to obtain the first password from the cryptograph module; and communicating with a service provider to authorize a client terminal when the first password matches the Access Password. For additional protection, the access control database may be encrypted using a master password.

The service provider may include a user information database that stores encrypted user information, and a decryption module that decrypts user information using the second password and grants the client terminal access to services when the access control server authenticates the client terminal. The encrypted user information may be encrypted using the Transient Password. However, neither the service provider, cryptographic module, nor the access control server may maintain a copy of the Transient Password.

The example authentication method may be used as an authentication system, and may include receiving a user password from a client, at a cryptograph module, and generating a first password using a first one-way cryptographic scheme and a second password using a second one-way cryptographic scheme. The first one-way cryptographic scheme and second one-way cryptographic scheme may be different cryptographic schemes, and may include MD5, SHA, DSA, and RSA, but is not limited thereto.

The example authentication method may further include receiving the first password, at an access control server, and matching the first password to an Access Password from an access control database. If the first password and Access Password match, the client terminal may be authenticated to a service provider.

The service provider may store encrypted user information on a user information database. Upon receiving the second password, the service provider may decrypt the encrypted user information using the second password, and grant the client terminal access to services after the access control server authenticates the client terminal and decrypts the encrypted user information.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1 illustrates a block diagram of a conventional authentication and authorization system.

FIG. 2 illustrates a first embodiment of an access control system in accordance with the present invention.

FIG. 3 illustrates a second embodiment of an access control system in accordance with the present invention.

FIG. 4 illustrates an access control method in accordance with the present embodiment.

FIG. 5A illustrates a first communication diagram for an example embodiment of the access control system in accordance with the present invention.

FIG. 5B illustrates a second communication diagram for an example embodiment of the access control system in accordance with the present invention.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

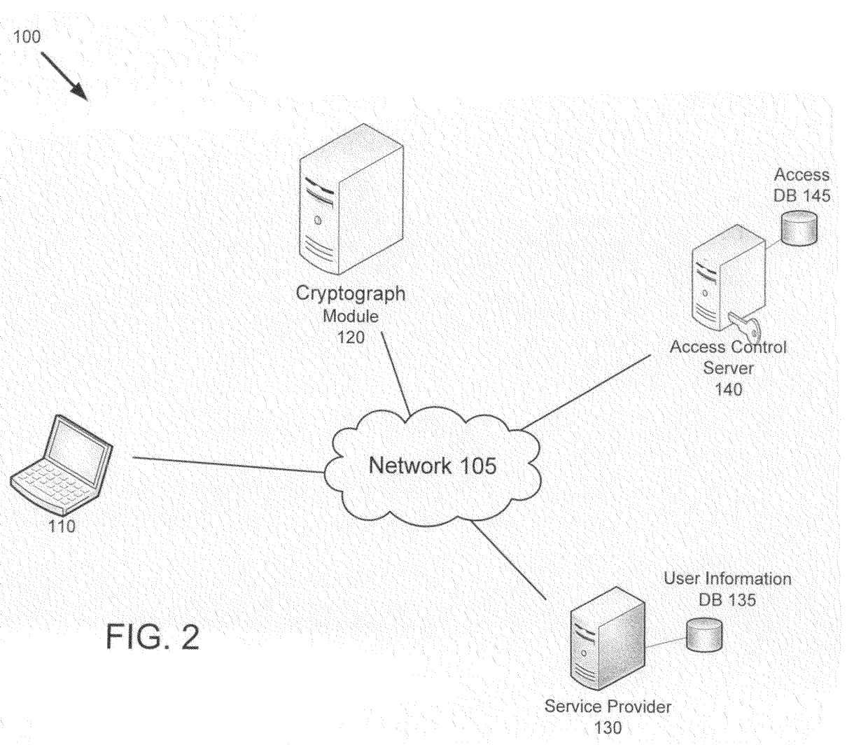

FIG. 2 illustrates an example of a secure system 100 in accordance of the present invention. The example 100 includes a client 110, a Cryptograph Module 120, Service Provider 130, and Access Control Server 140 which may all be connected via network 105.

Client 110 may be any device capable of communicating with a remote server. For example, client 110 may be a laptop or desktop computer, PDA, cellular phone, terminal, etc. Client 110 may include a display and input components that allow a user to provide login information and interact with any services which may be provided by Service Provider 130. Furthermore, client 110 may include a communication interface for transmitting and receiving information from Cryptograph Module 120, Service Provider 130, and Access Control Server 140 over a network. The network 105 may include, but is not limited to, the Internet, a local area network, wide area network, cellular network, etc.

Cryptograph Module 120 may be a communication device that includes at least one interface for communicating with client 110, Service Provider 130, and Access Control Server 140. Cryptograph Module 120 may be a stand alone server or may be a component of client 110. To prevent a malicious user from obtaining unauthorized access to services from Service Provider 130, Cryptograph Module 120 may be kept separate from the Service Provider 130, and Access Control Server 140.

Service Provider 130 may be a single computing device or a plurality or network of computer devices configured to provide services to the user of client 110. Services provided may include access to private or public resources and services, offers for sale of products, or any other services which may benefit from ensuring secure access to user related or associated information. Access to the services provided by Service Provider 130 is restricted to a set of authorized users. Authorized users may include those users that Access Control Server 140 has authorized to access services provided by Service Provider 130 over a network. Service Provider 130 may include at least one interface for communicating with client 110, Cryptograph Module 120, and Access Control Server 140. Service Provider 130 may also include or communicate with a User Information Database 135.

User Information Database 135 is a database of user information, which may include private and/or public user provided or related information. Each user's information stored on User Information Database 135 is encrypted using the Transient Password that corresponds to that specific user. As such, each individual user's information is encrypted using a key (i.e., the Transient Password) that is unique to that user. Therefore, the Transient Password is necessary to decrypt a given user's information, stored on database 135. The Transient Password may not be stored by Service Provider 130 or Access Control Server 140. Therefore, the user's login information (e.g., the user password) in conjunction with the cryptographic scheme employed by the Cryptograph Module 120, provides the only reasonable method by which the user's information can be retrieved from the Service Database 135. Alternatively, each user's information may be encrypted using a value derived, in part, based on the Transient Password. Further alternative embodiments may base the encryption on any other unique user-provided value.

Access Control Server 140 may be a single computing device, a plurality or a network of computer devices configured to authenticate the user of client 110, and authorize client 110 to access services from Service Provider 130. Access Control Server 140 may include at least one interface for communications with client 110, Cryptograph Module 120, and Service Provider 130 over a network. Access Control Server 140 may also include or communicate with an Access Control Database 145.

Access Control Database 145 is a database that correlates the user password and user authorization information with a given user. For example, each user ID in Access Control Database 135 may correspond to an expected password, which Access Control Server 140 may compare to the Access Password, to authenticate a user. The user authorization information may determine whether a given authenticated user may be authorized to access services provided by Service Provider 130. For example, user authorization information may include a list of authorized Service Providers 130 for a given user, or may identify the user as a member of a group that is entitled to access a given service. Alternatively, the Access Control Database 145 may provide any other known method for storing authentication and authorization information. Furthermore, the data stored in Access Control Database 145 may be encrypted using a master key, or may be encrypted using any other known encryption strategy.

A user (not shown) may provide user login information to client 110 which is transmitted to the Cryptograph Module 120. The login information may include a user ID and password, however, it is not limited thereto. Alternatively, the login information may include any other or additional information provided by the user, such as a fingerprint, retinal scan, etc., or combination thereof.

Using the login information, Cryptograph Module 120 may generate an Access Password using a first cryptographic scheme and a Transient Password using a second cryptographic scheme. The Access Password and Transient Password may be generated by hashing a password provided as login information, or may be generated by making use of any other combination of user provided information. The Access Password may be generated using a first one-way cryptographic scheme and the Transient Password may be generated using a second one-way cryptographic scheme. For example, the first and second cryptographic schemes may be two different one-way cryptographic schemes, such as SHA-1 and MD5. However, various other cryptographic schemes may be employed, such as DSA, RSA, or any other appropriate cryptographic schemes known in the art.

Alternatively, the Access Password and Transient Password may be generated using different combinations of user provided login information encrypted using the same one-way cryptographic scheme or different one-way cryptographic schemes.

Cryptograph Module 120 may transmit the Access Password to Access Control Server 140, along with the user ID. Access Control Server 140 may authenticate the user of client 110, using the Access Password by comparing a transmitted Access Password with an expected password from access control database 145 corresponding to the user ID. After authenticating the user of client 110, Access Control Server 140 may determine whether the user of client 110 is authorized to access Service Provider 130. If Access Control Server 140 determines that the user of client 110 is authorized to use Service Provider 130, Access Control Server 140 may authorize client 110 to access to Service Provider 130, in which case the Access Control Server 140 may issue an authorization message to Service Provider 130 indicating that client 110 is authorized to obtain services from Service Provider 130.

While, or after, Access Control Server 140 authorizes client 110, Service Provider 130 may receive the Transient Password from Cryptograph Module 120. The Service Provider then communicates with Access Control Server 140 to determine if client 110 is authorized to access the services from Service Provider 130.

In one embodiment, Service Provider 130 may receive the Transient Password and then request authorization from the Access Control Server 140. In response, Access Control Server 140 may provide an access authorization message to Service Provider 130. In another embodiment, Access Control Server 140 may automatically transmit an access authorization message to Service Provider 130, after authenticating client 110 using the Access Password.

Once Service Provider 130 receives the Transient Password and access authorization message, the Service Provider 130 retrieves the user information stored on database 135. Service Provider 130 then decrypts the user information stored on database 135 and provides client 110 access to the services provided by Service Provider 130 which may include access to user information and/or services that make use of the user information.

Finally, as a precautionary step, the Service Provider may destroy or over-write any available copy of the Transient Password once communications with client 110 conclude. Alternatively, Service Provider may destroy or over-write any available copy of the Transient Password after decrypting or encrypting the user information.

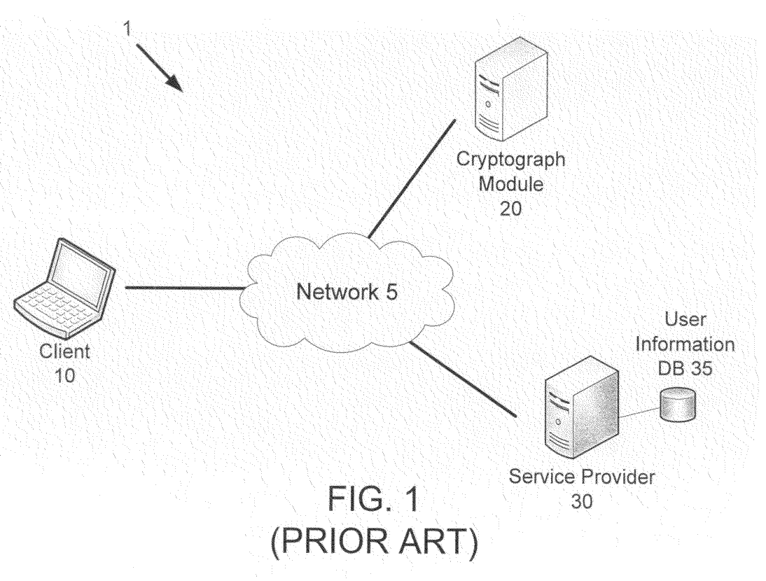

Secure System 100 overcomes the security problems that persist in the conventional authentication and authorization system illustrated in FIG. 1, by separating and using different keys to perform user authentication and data access processes.

For example, even if a malicious user obtains control of the Access Control Server 140 or Access Control Database 145, the malicious user will be unable to decrypt the user information stored in user information database 135. This is because the user information stored in user information database 135 is encrypted using the Transient Password, which is not stored anywhere. Furthermore, if the malicious user obtains control of the Service Provider 140 or Access Control Database 145, the malicious user will still be unable to decrypt the user information stored in user information database 135.

Alternatively, if a malicious user monitors the communications of the Service Provider and obtains a user's Transient Password, the malicious user may still be unable to gain access to the Service Provider because the malicious user will be unable to become authenticated by the Access Control Server.

Finally, if a malicious user manages to take control of the Cryptograph Module 120, the malicious user may still be unable to gain access to the Service Provider without the user's password.

By this technique, the example embodiment 100 provides enhanced security for the user information stored on user information database 135.

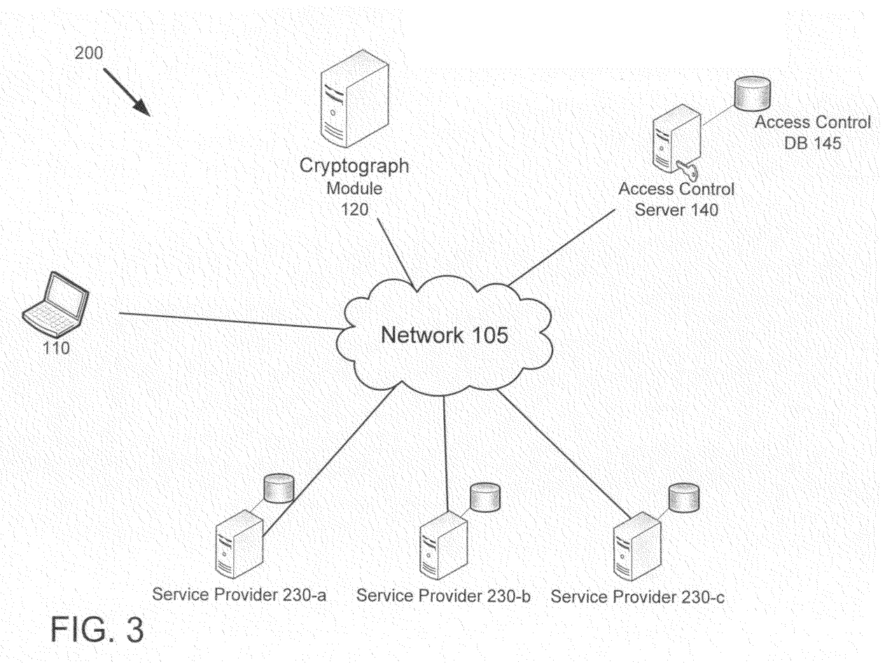

FIG. 3 illustrates another example embodiment of a secure system 200 in accordance of the present invention. Like FIG. 2, this embodiment includes a client 110, Cryptograph Module 120, Access Control Server 130, but also includes a plurality of Service Providers 230-a to 230-c. Secure system 200 employs a similar access control scheme to secure system 100. However, whereas, in FIG. 2, the Access Control Server 140 controls access to a single Service Provider 130, in FIG. 3, the Access Control Server 140 controls access to a plurality of Service Providers 230-a to 230-c. As such, example embodiment 200 may provide a system whereby a single Access Control Server 140 can manage the authentication and authorization for a plurality of Service Providers 230, while providing enhanced protection to user information.

In secure system 200, upon receiving the Access Password, Access Control Server 140 authenticates the user of client 110, and identifies which of the Service Providers 230 client 110 may access. For example, client 110 may be authorized to only access Service Providers 230-a and 230-b, but not 230-c. In this case, Access Control Server 140 will only send authorization messages authorizing client 110 to access Service Providers 230-a and 230-b. Alternatively, after Access Control Server 140 may authorize the user of client 110, any Service Provider 130 may communicate with Access Control Server 140 to verify that client 110 has been authorized to access a given service.

Furthermore, in secure system 200, Cryptograph Module 120 may transmit the Transient Password to all, or a portion, of Service Providers 230-a to 230-c. Similarly, to Service Provider 130, Service Providers 230-a to 230-c may encrypt their respective user information using the Transient Password as an encryption and/or decryption key. Alternatively, Cryptograph Module 120 may transmit a different Transient Password to each Service Providers 230-a to 230-c with which client 110 may communicate. In this case, each of Service Providers 230-a to 230-c may encrypt or decrypt their respective user information using a different Transient Password as a encryption and/or decryption key.

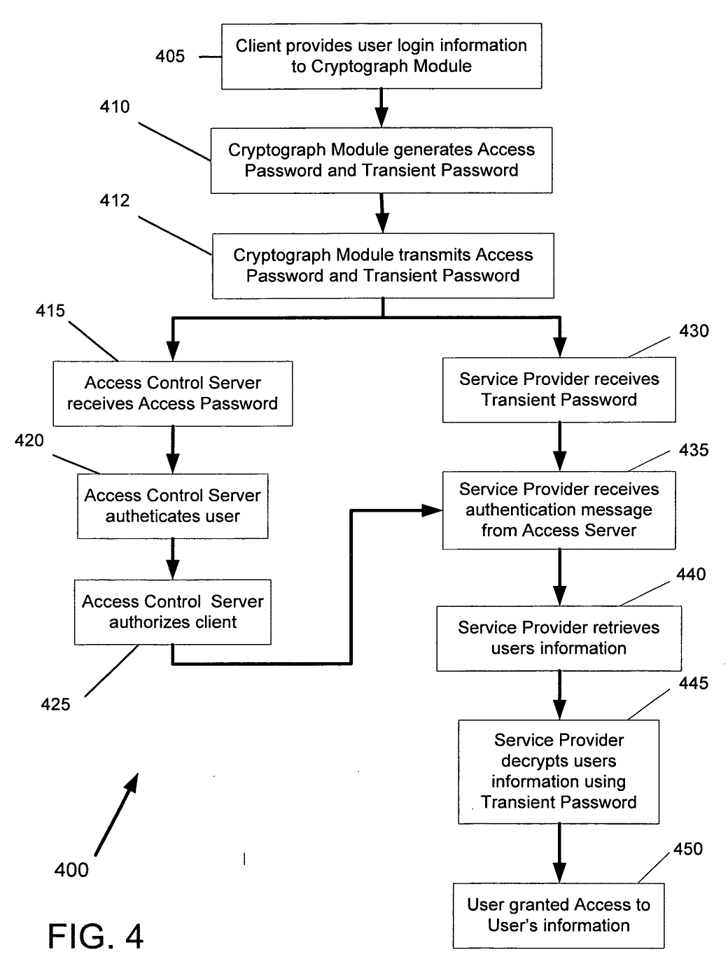

FIG. 4 illustrates an access control method 400 in accordance with the present embodiment.

The process begins, at step 405, when client 110 provides login information to the Cryptograph Module 120. For example, the user login information may include a user ID and password.

At step 410, the Cryptograph Module 120 generates an Access Password and Transient Password from the login information. The Access Password and the Transient Password maybe be generated using different one-way cryptographic schemes. Thereafter, at step 412, the Access Password and the Transient Password are transmitted to Access Control Server 140 and Service Provider 130, respectively.

At step 415, the Access Control Server 140 receives the Access Password and, at step 420, authenticates the user of client 110 using the Access Password. Once the user of client 110 is authenticated, at step 425, the Access Control Server 140 authorizes client 110 to access the services provided by Service Provider 130. The authorization is sent from Access Control Server 140 to the Service Provider 130.

While, or after, Access Control Server 140 processes steps 415-425, at step 430, Service Provider 130 receives the Transient Password from Cryptograph Module 120.

At step 435, the Service Provider 130 waits until an authorization message, authorizing client 110 to access services on Service Provider 130, is received.

Upon receiving both the client authorization message and Transient Password, at step 440, the Service Provider 130 retrieves the user's information from the user information database 135. Then, at step 445, the Service Provider decrypts the user's information using the Transient Password or its derivative as a decryption key. Such a derivative may include any value which can be reliably regenerated, using the Transient Password alone or in conjunction with other data.

Having decrypted the user's information, at step 450, the Service Provider 130 may provide access to the Service Provider services and/or user's information.

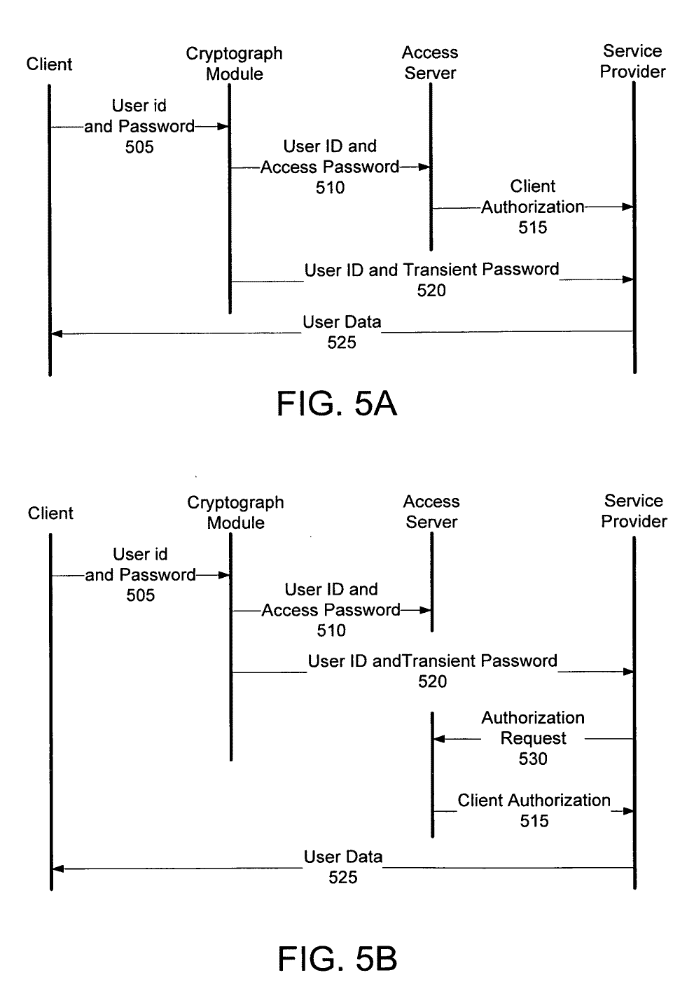

FIG. 5A illustrates a communication diagram for an example embodiment of the method in accordance with the present invention. Communications begin when client 110 provides a user ID and password message 505 to the Cryptograph Module 120. The Cryptograph Module 120 generates and transmits the user ID and Access Password message 510 to Access Control Server 140 and the user ID and Transient Password message 520 to Service Provider 130.

After receiving the user ID and password message 510, the Access Control Server 140 may authenticate the user of client 110 and automatically issues client authorization message 515 to the Service Provider 130. In this embodiment, Service Provider 130 does not need to specifically request any authorization for client 110, as the Access Control Server may automatically identify which services a given client may authorize and may issue a client authorization message 515 to any Service Provider 130 associated with the user of client 110.

Upon receiving both the user authentication message 515 and Transient Password message 520, Service Provider 130 may retrieve the user information from the user information database 135 and decrypt the user information using the Transient Password as a decryption key. The Service Provider may then either transmit the user data 525 to client 110 or, alternatively, provide other services to the client based on user information.

FIG. 5B illustrates a communication diagram for an example embodiment of the method in accordance with the present invention. Communications begin when client 110 provides a user ID and password message 505 to the Cryptograph Module 120. The Cryptograph Module 120 may generate and transmit a user ID and an Access Password message 510 to Access Control Server 140 and a user ID and Transient Password message 520 to Service Provider.

After receiving the user ID and password message 510, the Access Control Server 140 authenticates the user of client 110. Unlike FIG. 5A, in this embodiment, Service Provider 130 may not issue a client authorization message 515, unless a specific Service Provider 130 transmits an authorization request 530 to the Access Control Server 140. Therefore, the Access Control Server 140 may simply authenticates the user and, thereafter, wait to receive an authentication request 530 for a given client, before issuing a client authorization message 515 to the Service provider 130.

Upon receiving the user ID and Transient Password message 520, Service Provider may issue an authorization request 530 to the Access Control Server 130, for authentication of client 110. If client 110 has been authenticated, then Access Control Server 140 may send a client authorization message 515 to Service Provider 130.

After receiving both the client authorization message 515, Service Provider 130 may retrieve and decrypt the user information from the user information database 135 using Transient Password 520 as a decryption key. The Service Provider then may transmit the user data 525 to be client 110 or, alternatively, provide other services to the client based on user information.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Processes may also be implemented as computer-executable instructions (e.g., as one or more scripts), stored procedures, executable programs, etc. on a client, server, and/or database. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but instead with reference to the appended claims, along with the full scope of equivalents to which such claims are entitled. It is anticipated and intended that future developments will occur in the arts discussed herein, and that the mentioned systems and methods will be incorporated into such future embodiments. In sum, it should be understood that the invention is capable of modification and variation and is limited only by the following claims.

Computing devices (e.g., clients, servers, databases, etc.), such as those discussed herein generally may include instructions executable by one or more processors. Computer-executable instructions may be compiled or interpreted from computer programs created using a variety of programming languages and/or technologies known to those skilled in the art, including, without limitation, and either alone or in combination, Java™, C, C++, Visual Basic, Java Script, Perl, etc. In general, a processor (e.g., a microprocessor), receives instructions (e.g., from a memory, a computer-readable medium, etc), and executes these instructions, thereby performing one or more processes, including one or more of the processes described herein. Such instructions and other data may be stored and transmitted using a variety of known computer-readable media.

Databases or data stores described herein may include various kinds of mechanisms for storing, accessing, and retrieving various kinds of data, including a hierarchical database, a set of files in a file system, an application database in a proprietary format, a relational database management system (RDBMS), etc. Databases or data stores described herein may also store information on one or a plurality of computer readable mediums. Each such database or data store is generally included within a computing device employing a computer operating system, such as one of those mentioned above, and is accessed via a network in any one or more of a variety of manners, as is known. A file system may be accessible from a computer operating system, and may include files stored in various formats. An RDBMS generally employs the known Structured Query Language (SQL) in addition to a language for creating, storing, editing, and executing stored procedures, such as the PL/SQL language mentioned above.

A computer-readable medium includes any medium that participates in providing data (e.g., instructions), which may be read by a computer. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory.

Communications between computing devices, and within computing devices may employ transmission media including coaxial cables, copper wire, and fiber optics, including the wires that comprise a system bus coupled to the processor. Transmission media may include or convey acoustic waves, light waves, and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Thus embodiments of the present invention produce and provide a SYSTEM AND METHOD FOR SECURING INFORMATION USING REMOTE ACCESS CONTROL AND DATA ENCRYPTION. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. An authentication system, comprising:
a cryptograph module, that receives a user password from a client terminal and generates a first password using a first one-way cryptographic scheme and a second password using a second one-way cryptographic scheme;
an access control server, including an access control database that stores an access password, and an interface for communicating with the cryptograph module to obtain the first password from the cryptograph module, and communicating with a service provider to authorize a client terminal when the first password matches the access password;
the service provider having a user information database that stores encrypted user information, and a decryption module that decrypts user information using the second password and grants the client terminal access to services when the access control server authenticates the client terminal.

2. The authentication system of claim 1, wherein the first one-way cryptographic scheme and second one-way cryptographic scheme are different cryptographic schemes.

3. The authentication system of claim 1, wherein the first one-way cryptographic scheme and second one-way cryptographic scheme include at least two of MD5, SHA, DSA, and RSA.

4. The authentication system of claim 1, wherein the access password in the access database is encrypted using a master password.

5. The authentication system of claim 1, wherein the encrypted user information is encrypted using the transient password.

6. The authentication system of claim 1, wherein the service provider does not maintain a copy of the transient password.

7. The authentication system of claim 1, further comprising a second service provider having a second user information database that stores second encrypted user information, and a second decryption module that decrypts user information using the second password and grants the client terminal access to services when the access control server authenticates the client terminal.

8. The authentication system of claim 1, wherein the cryptograph module generates a third password using a third one-way cryptographic scheme, and further comprising a second service provider having a second user information database that stores encrypted user information, and a second decryption module that decrypts user information using the third password and grants the client terminal access to services when the access control server authenticates the client terminal.

9. An authentication method used by an authentication system, comprising:
receiving a user password from a client, at a cryptograph module, and generating a first password using a first one-way cryptographic scheme and a second password using a second one-way cryptographic scheme;
receiving the first password, at an access control server, and matching the first password to an access password from an access control database;
authenticating a client terminal, to a service provider when the first password matches the access password;
storing encrypted user information on a user information database;
receiving the second password, at the service provider, and decrypting the encrypted user information using the second password;
granting the client terminal access to services after the access control server authenticates the client terminal and decrypts the encrypted user information.

10. The authentication method of claim 9, wherein the first one-way cryptographic scheme and second one-way cryptographic scheme are different cryptographic schemes.

11. The authentication method of claim 9, wherein the first one-way cryptographic scheme and second one-way cryptographic scheme include at least two of MD5, SHA, DSA, and RSA.

12. The authentication method of claim 9, further comprising encrypting the access password in the access database using a master password.

13. The authentication method of claim 9, further comprising encrypting user information using the transient password to generate the encrypted user information.

14. The authentication method of claim 9, destroying the transient password after decrypting the user information.

15. The authentication method of claim 9, further comprising
storing a second encrypted user information on a second user information database;
receiving the second password, at a second service provider, and decrypting the second encrypted user information using the second password;
granting the client terminal access to services after the access control server authenticates the client terminal and decrypts the second encrypted user information.

16. The authentication method of claim 9, further comprising
generating a third password, at a cryptograph module, using a third one-way cryptographic scheme;
storing a second encrypted user information on a second user information database;
receiving the third password, at a second service provider, and decrypting the second encrypted user information using the third password;
granting the client terminal access to services after the access control server authenticates the client terminal and decrypts the second encrypted user information.

17. An authentication method used by an access control server, comprising:
receiving a password, corresponding to a client;
matching the password to an access password, from an access database, corresponding to the client;
authenticating the client, to a service provider, if the password matches the access password.

18. The authentication method of claim 17, further comprising receiving an authentication request from a service provider for the client; and authenticating the client in response to the authentication request.

19. The authentication method of claim 17, further comprising:
identifying a service provider associated with a user of the client after matching the password to an access password; and
wherein the authenticating step includes automatically transmitting a notification to the identified service provider after successfully matching the password to the access password.

20. The authentication method of claim 17, wherein the password is a one-way cryptographic hash generated by a cryptograph module, using an original password provided to the cryptograph module from a client terminal.

21. An authentication method used by a service provider, comprising:
storing encrypted user information on a service database;
receiving a password, corresponding to a client;
receiving an authentication transmission from an access control server authenticating the client;
decrypting the user information, corresponding to the client, using the password;
granting the client access to services after receiving the authentication transmission and decrypting the user information.

22. The authentication method of claim 21, further comprising sending an authentication request, identifying the client, to the access control server.

23. The authentication method of claim 21, wherein the password is a one-way cryptographic hash generated by a cryptograph module, using an original password provided to the cryptograph module from the client.

24. The authentication method of claim 23, wherein the service provider receives the authentication transmission from the access control server after the access control server receives a second password and matches the second password to a stored access password, the second password being a second one-way cryptographic hash generated by a cryptograph module based on the original password provided to the cryptograph module by the client.
